(19) United States
(12) Patent Application Publication
(10) Pub. No.: US 2008/0041656 A1
(43) Pub. Date: Feb. 21, 2008

(54) Low-Cost, Programmable, Time-Limited Hearing Health aid Apparatus, Method of Use, and System for Programming Same

(75) Inventors: Mark Burrows, Princeton, NJ (US); John Cronin, Jericho, VT (US); Tom Hunt, Shelbourne, VT (US); Steven A. Shaya, Highlands, NJ (US); John Anthony Singarayar, Skillman, NJ (US)

Correspondence Address: NORRIS MCLAUGHLIN & MARCUS, P.A., P O BOX 1018, SOMERVILLE, NJ, 08876, US

(73) Assignee: JOHNSON & JOHNSON CONSUMER COMPANIES INC,, SKILLMAN NEW JERSEY, NJ (US)

(21) Appl. No.: 11/570,469

(22) PCT Filed: Jun. 14, 2005
(86) PCT No.: PCT/US05/20869

§ 371 Date: Oct. 31, 2007

Related U.S. Application Data
(60) Provisional application No. 60/579,948, filed on Jun. 15, 2004.

(51) Int. Cl. H04R 25/00

(52) U.S. Cl. 181/129

(57) ABSTRACT

A low-cost, programmable, time-limited hearing aid (104) and a means (102) to program the hearing aid with user-specific hearing-loss data (101) for the purpose of emulating the performance of a more permanent, but more costly, hearing aid device. The hearing aid is operational for only a limited time, and is intended for temporary, evaluative purposes. By providing the user with a low-cost, but temporary, means to evaluate the benefits of assisted hearing, he or she becomes more comfortable with its use, and therefore is more amenable to the more involved process and greater expense of being fitted for a more permanent hearing health solution. A method of use of the hearing health aid and the associated programming system that allows a hearing-loss candidate to evaluate the effectiveness of the hearing aid device is also presented.

### CROSS REFERENCE TO RELATED APPLICATION

This application claims the benefit of U.S. Provisional Application No. 60/579,948 filed Jun. 15, 2004, assigned to the assignee of this application and incorporated by reference herein. The subject matter of International Application No. ______, filed Jun. 10, 2005 and entitled “A System for and Method of Conveniently and Automatically Testing the Hearing of a Person” assigned to the assignee of this application, is related to this application.

### FIELD OF THE INVENTION

The present invention relates to a low-cost, programmable, time-limited hearing health apparatus, method of using, and system for programming same. More particularly, the present invention provides a low-cost, programmable, time-limited hearing health aid, and a means to program the hearing health aid with user-specific hearing-loss data for the purpose of emulating the performance of a more permanent, but more costly, hearing aid device.

### BACKGROUND OF THE INVENTION

About two million hearing aids are sold annually in the U.S., generating $2.6 billion in revenue. Although 28 million Americans are hearing impaired, only six million of them use hearing aids. Year after year, market penetration has increased little, making it apparent that factors other than patient need have inhibited market penetration. Central among these factors is the product-centric (as opposed to patient-centric) approach that the hearing aid industry has taken to fitting hearing aids. Hearing aid manufacturers concentrate marketing efforts almost solely on improving their devices, most notably with digital signal processing (DSP), while other patient needs and preferences are virtually ignored.

Conventionally, a person who suspects that he or she suffers from hearing loss must visit a professional audiologist who tests the person's hearing for sensitivity by pitch; the test results are then sent to the hearing-aid manufacturer that programs the hearing aid. Once programmed, the hearing aid is subsequently shipped to the audiologist, who places it in the patient's ear, and then tests the patient's hearing. When patients finally reach this stage in the laborious purchase process, trying out the hearing aid for the first time in the professional's office, the audiologist is unable to adjust the device's programming, let alone optimize that programming by tuning discrete frequency ranges to compensate for an individual's hearing-loss and preferences in each of those discrete frequency ranges.

While a professional hearing test is complete and allows for a thorough diagnostic, most hearing-impaired individuals are not even aware that they are in need of a hearing test, and so may not be motivated to incur the expense and bother of an office visit to an audiologist. Indeed, even if a patient is aware of hearing loss, he or she may not be inclined to initiate the arduous process of acquiring a hearing aid without further proof of the quality-of-life benefits of assisted hearing.

Recently, new methods for testing hearing loss that do not require a visit to an audiologist's office have been developed. One method, based on a program available on the Internet, allows a user to log onto a free hearing test Web site, adjusts his or her computer speaker volume to a supplied test frequency, and uses a mouse to click on various hyperlinks on a Web page on which the user can listen to various tones and determine how many tones he or she is able to hear. The user then is guided to instructional and “next step” pages.

Another method, mentioned above in the cross references to related applications, described in “A System for and Method of Conveniently and Automatically Testing the Hearing of a Person”, and which is incorporated by reference herein, is a hearing test stored on a centrally located computer that is accessible either via a toll-free telephone number or via a personal computer with an Internet connection to the centrally located computer. The central computer system is a central repository for current audiological programs, audiological data, audiological research, sound “.wav” files, speech, and other sound simulations files. The hearing test program resident on the central computer generates and transmits sound signals which provide for sound outputs at various amplitudes at the phone handset or personal computer speakers and prompts a user to interact by responding either verbally or through a keypad. In addition, the program can determine the user's level of speech intelligibility by playing pre-defined sentences for the user for their understanding and response. In this way, the user can take a low-cost, at-home hearing test. Based on the results of the test, the test program then provides step-by-step guidance on the user's next steps. The present invention also provides a way to store and organize the user test data in order to facilitate reuse of the data.

With the advent of at-home hearing diagnostics, it becomes important to engage participants in a process of simple next steps that will result in the most efficacious hearing health solution possible. What is needed is a way to more clearly demonstrate the benefits of assisted hearing, while at the same time reducing the cost and effort of acquiring it.

It is therefore an object of the present invention to provide a low-cost means to clearly demonstrate the benefits of assisted hearing.

### SUMMARY OF THE INVENTION

The present invention provides a low-cost, programmable, time-limited hearing health aid, and a means to program the hearing health aid with user-specific hearing-loss data for the purpose of emulating the performance of a more permanent, but more costly, hearing aid device. “Time-limited” means that the hearing health aid is designed to be operational for a limited time, and is intended for temporary, evaluative purposes. By providing the user with a low-cost, but temporary, means to evaluate the benefits of assisted hearing, he or she becomes more comfortable with its use, and therefore is more amenable to the more involved process and greater expense of being fitted for a more permanent hearing health solution. A method of use of the hearing health aid and the associated programming system that allows a hearing-loss candidate to evaluate the effectiveness of the hearing aid device is also presented.

Thus, the present invention provides for a programmable hearing aid device comprising:
a controller including a processor and memory, wherein the controller is coupled to a microphone, a speaker and a data signal communications interface (e.g., optionally having wireless receiving capabilities):
wherein the processor is operable to execute an audio data signal processing program using digital signal processor (“DSP”) correction factors stored in the memory for modifying a sound input signal representative of sound input received at the microphone; and

wherein the processor includes a counter and a programmable timing means for disabling operations of the hearing aid device after a predetermined count is reached at the counter.

In a further embodiment of the hearing aid device, the controller stores in the memory data representative of patient use diary data received at the interface (e.g., from a wireless remote or based on activation of switches on the hearing aid device.)

In still a further embodiment of the hearing aid device, the controller is operable, based on control data signals received at the interface, to retrieve the patient use diary data from the memory and transmit the patient use diary data at the interface.

In a further embodiment of the hearing aid device, the counter is resettable based on control signals received at the interface.

In a further embodiment of the hearing aid device, the controller causes the DSP to transmit at least one warning (e.g., time limit almost reached) audio signal based on the count at the counter (e.g., such that the speakers play a warning sound).

In a further embodiment of the hearing aid device, the controller, upon receipt of new DSP correction factors signals at the interface, stores the new DSP correction factors in the memory.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a high-level system diagram of a programming system for a low-cost, time-limited hearing health aid.

FIG. 2 represents a detailed functional block diagram of the hearing health aid apparatus.

FIG. 3 is a method of using the low-cost, time-limited hearing health aid.

### DESCRIPTION OF THE INVENTION

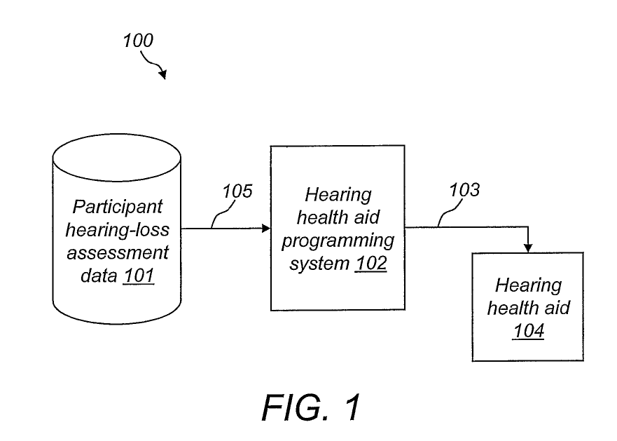

FIG. 1 is a high-level diagram of a system 100, including a plurality of participant hearing-loss assessment data 101, a hearing health aid programming system 102, a programming interface 103, a hearing health aid 104, and a data storage interface 105.

Participant hearing-loss assessment data 101 is data collected from a person who has participated in a hearing-loss screening test. A professional audiologist may have administered the hearing-loss screening test, or it may have been self-administered using an at-home screening test. Participant hearing-loss assessment data 101 is stored in digital form within a data storage device, such as a hard disk drive, and represents user demographic information as well as the user's hearing loss profile with associated correction factors.

Hearing health aid programming system 102 is a computer system capable of executing software programs. Hearing health aid programming system 102 is capable of accessing participant hearing-loss assessment data 101 through data storage interface 105. In one embodiment, hearing health aid programming system 102 is a general-purpose computer. In another embodiment, hearing health aid programming system 102 is a computer system designed for the specific purpose of hearing health aid programming.

Hearing health aid programming system 102 is capable of accessing participant hearing-loss assessment data 101 through data storage interface 105. Data storage interface 105 is any data communication path that may be used to transfer data to and from the data storage device containing participant hearing-loss assessment data 101. Examples include SCSI, IDE bus, Fiber Channel, and Firewire, among others. Hearing health aid programming system 102 is further connected to hearing health aid 104 via programming interface 103. Programming interface 103 is a data communications pathway providing a way for hearing health aid programming system 102 to program the functionality of hearing health aid 104. In one embodiment, programming interface 103 is a standard serial bus such as I²C bus, RS232, or other.

Hearing health aid 104 is a low-cost, programmable, time-limited hearing health aid. “Time-limited” means that hearing health aid 104 is designed to be operational for a limited time, and is intended for temporary, evaluative purposes.

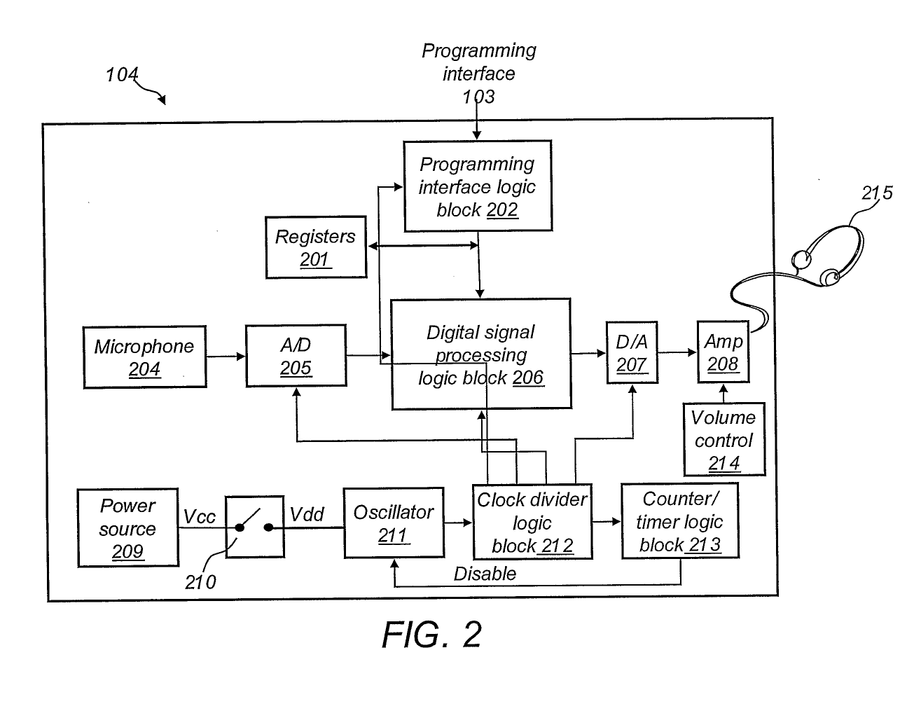

FIG. 2 is a detailed functional block diagram of hearing health aid 104. Hearing health aid 104 further includes a plurality of registers 201, a programming interface logic block 202, a microphone 204, an analog/digital converter (A/D) 205, a digital signal processing logic block 206, a digital/analog converter (D/A) 207, an amplifier (amp) 208, a power source 209, an on/off switch 210, an oscillator 211, a clock divider logic block 212, a counter/timer logic block 213, a volume control 214, and a set of headphones 215.

The functional blocks of hearing health aid 104 are connected as shown in FIG. 2. Programming interface logic block 202 communicates with hearing health aid programming system 102 of FIG. 1 via programming interface 103, providing proper signal levels and bus protocol. Through programming interface logic block 202, hearing health aid programming system 102 is provided access to registers 201 and internal memory locations within digital signal processing logic block 206. Registers 201 are programmable control and status registers with connections (not shown) to various functional blocks of hearing health aid 104. Digital signal processing logic block 206 contains the necessary digital logic to store and execute signal processing software algorithms. Included (but not shown) in digital signal processing logic 206 is a digital signal processor and non-volatile memory. Other embodiments may include volatile memory and other support logic.

A/D 205 converts analog signals generated by conventional microphone 204 into digital data for input to digital signal processing logic block 206. D/A 207 is dual channel, and converts right and left channel digital output data generated by digital signal processing logic block 206 into analog signals to be output to amp 208. Amp 208 is a stereo audio amplifier that provides output signal levels suitable for conventional headphones 215. The amplitude gain of amp 208 is variable and can be controlled by the user via volume control 214.

Power source 209 is a battery capable of fitting into the small footprint of hearing health aid 104 and supplying the necessary power for the intended operating lifetime of the device. It is important to note that, although it is not explicitly shown in FIG. 2, constant power signal Vcc is supplied only to counter/timer logic block 213 and to the input of on/off switch 210 in order to provide uninterrupted power to counter/timer logic block 213. On/off switch 210 is under user control and outputs an interruptible power signal, Vdd, to the rest of the functional logic blocks within hearing health aid 104.

Oscillator 211 provides a base clock signal output that is divided down by clock divider logic block 212 to provide multiple clock outputs with frequencies appropriate for use in the various functional blocks. Counter/timer logic block 213 uses one such clock output to sequentially count down (or up) to some threshold value and then generate a Disable signal that is used to prevent oscillator 211 from generating further base clock pulses.

Programmable hearing aids with digital processing elements are well known in the conventional art. However, these conventional devices are intended for long-term use, and must be miniaturized to the point of fitting in or on the wearer's ear. Hearing health aid 104 is intended to be portable, but need only be small enough to allow it to be clipped to a lapel or shirt pocket, as it is only meant as a temporary emulator of what may later become a more permanent and feature-rich hearing aid device. In one embodiment of hearing health aid 104, the various functional blocks are implemented with off-the-shelf components mounted on, and electrically connected through, printed circuit board material. In another embodiment, the functional blocks are integrated into one or more application-specific integrated circuits.

In operation, hearing health aid 104 is first programmed with digital signal processing algorithms and control register information. The digital signal processing algorithms are produced by hearing health aid programming system 102 using participant hearing-loss assessment data 101, and therefore are specific to the hearing-loss profile of the participant. This provides hearing health aid 104 with the means to alter the frequency/amplitude characteristics of the incoming audio signal received by microphone 204 to produce an output audio signal with increased signal amplitude for those frequency ranges at which the participant's hearing sensitivity has been compromised. The digital signal processing algorithms are then downloaded to non-volatile memory within digital signal processing logic block 206 via programming interface 103.

With on/off switch 210 in the “on” position, all circuit functions within health hearing aid 104 are energized. Oscillator 211 produces a base clock signal, which is then divided down by clock divider logic block 212 and distributed to all logic functions needing such timing signals. Microphone 204, A/D 205, digital signal processing logic block 206, D/A 207, and amp 208 combine to take input audio signals, digitally enhance the input audio signals based on participant-specific hearing-loss data, and output the enhanced audio data to the user via headphones 215.

Counter/timer logic block 213 only counts when on/off switch 210 is in the “on” position, allowing oscillator 211 to generate base clock pulses. Counter/timer logic block 213 uses a clock output from clock divider logic block 212 to sequentially count down (or up) to some threshold value. When the threshold value has been reached, counter/timer logic block 213 generates a Disable signal that is used to prevent oscillator 211 from generating further base clock pulses. This has the effect of preventing further operation of hearing health aid 104, providing the desired usage time limit. By judicious choice of counter threshold value and clock frequency, a wide range of time limits can be created. Because counter/timer logic block 213 is supplied with constant power signal Vcc, it can maintain a count even though on/off switch 210 may be in the “off” position. The power usage of counter/timer logic block 213 is minimal when on/off switch 210 is in the “off” position because the logic is not switching, and therefore should not negatively impact the lifetime of the battery. The timer may be set, for example, for 60 hours, which would allow an individual user to really get a feel for their personalized hearing assistance.

Because the audio output of D/A 207 is dual channel, it is possible to digitally enhance the audio frequency/amplitude characteristics for either or both ears. This is an important capability of hearing health aid 104, as it allows the device to adapt to those participants with either uni- or bi-lateral hearing-loss.

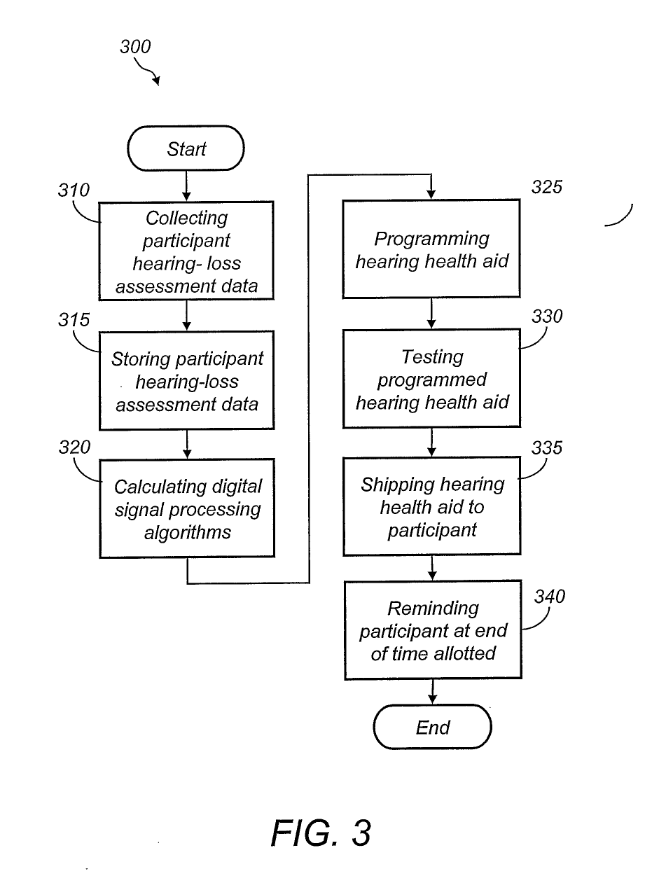

The capabilities of system 100 as illustrated in FIG. 1, and described herein, provide a hearing-loss candidate with an improved method of evaluating the effectiveness of a hearing aid device. FIG. 3 illustrates a method 300 of using system 100. The steps include:

Step 310: Collecting Participant Hearing-Loss Assessment Data

In this step, using a Web-based testing facility, the participant interacts with the testing program to determine the extent and nature of the participant's hearing-loss. Participant hearing-loss assessment data 101 is then generated based on the participant's responses. An example of such a Web-based testing facility is described in “A System for and Method of Conveniently and Automatically Testing the Hearing of a Person”, referenced above.

Step 315: Storing Participant Hearing-Loss Assessment Data

Participant hearing-loss assessment data 101 is subsequently stored in a storage device accessible to hearing health aid programming system 102.

Step 320: Calculating Digital Signal Processing Algorithms

Using hearing-loss assessment data collected and stored in the previous steps, hearing health aid programming system 102 calculates the appropriate digital signal processing algorithms to produce audio output to address the specific hearing-loss profile of the participant.

Step 325: Programming Hearing Health Aid

In this step, hearing health aid programming system 102 downloads digital signal processing algorithms to non-volatile memory within digital signal processing logic block 206 via programming interface 103.

Step 330: Testing Programmed Hearing Health Aid

In this step, to ensure that hearing health aid 104 operates correctly once programmed, input audio data is provided to hearing health aid 104 and output audio waveforms are analyzed for correct frequency/amplitude characteristics.

Step 335: Shipping Hearing Health Aid to Participant

In this step, the programmed and tested hearing health aid 104 is shipped to the participant for evaluation. In one embodiment, hearing health aid 104 can be sent automatically to the user, whereas in another embodiment, hearing health aid 104 can be sent after the user requests one. In yet another embodiment, hearing health aid 104 can be sent to the user with nominal state or default state settings. This is preferable in scenarios where prior user hearing loss assessment and profile data is not available.

Step 340: Reminding Participant at End of Time Allotted

In this step, the user is sent a reminder near the end of the time allotted for use of hearing health aid 104. In the reminder, the user can be given several options, such as an option to purchase a hearing aid at lower cost through a “manufacturers coupon” after the user has returned hearing health aid 104, or an option to extend the trial period of hearing health aid 104. Further, after the user has returned health aid 104, periodic reminders can be sent to the user regarding the benefits of a hearing aid, and a savings incentive “coupon” can be attached to the reminders. Method 300 ends.

The participant uses hearing health aid 104 for the time allotted. After the use allotment has elapsed, the user is further enticed to visit an audiologist for a professional test because he or she has enjoyed the improvement to his or her quality of life and is now without it.

It is further possible for the audiologist, having conducted an improved test such as described in “A System for and Method of Conveniently and Automatically Testing the Hearing of a Person”, referenced above, to reprogram hearing health aid 104 with the improved data and to reset the time electronically, so that the user can have the improved quality of life while waiting for the permanent hearing aid that has been ordered.

It is further possible to provide a “time left” counter display on hearing health aid 104 so that the user can plan ahead to visit the audiologist and, in so doing, need never be without the improved quality of life that accompanies improved hearing.

It is further possible to add a “patient use diary” feature on hearing health aid 104. The “patient use diary” can store information on how the user has used hearing health aid 104, while it was in the user's possession. This allows improved programming and customization of the permanent hearing aid that has been ordered by the user. For example, if it is determined that the primary use of the permanent hearing aid for a particular user will be to watch TV then the permanent hearing aid can be specifically programmed to optimize the reception of sound from a TV. The “patient use diary” feature can be facilitated via selection switches on the hearing aid and coupled to the interface, or by including wireless signal receiving capabilities at the programming interface. In the aforementioned example, every time the user with hearing health aid 104 watches TV he/she presses a switch or transmits a predetermined (e.g., radio frequency) sound code signal from at a remote control compatible with the hearing health aid 104 to indicate that hearing health aid 104 is being used while watching TV. In turn, this use information, received at the programming interface, gets stored in a memory of the hearing health aid 104, and can be later retrieved while programming the permanent hearing aid.

Although preferred embodiments of the present invention have been described and illustrated, it will be apparent to those skilled in the art that various modifications may be made without departing from the principles of the invention.

What is claimed is:

1. A programmable hearing aid device comprising:
a controller including a processor and memory, wherein the controller is coupled to a microphone, a speaker and a data signal communications interface;
wherein the processor is operable to execute an audio data signal processing program using digital signal processor (“DSP”) correction factors stored in the memory for modifying a sound input signal representative of sound input received at the microphone.

2. The hearing aid device of claim 1, wherein the communication interface includes wireless receiving capabilities.

3. The hearing aid device of claim 1, wherein the processor includes a counter.

4. The hearing aid device of claim 3, wherein the processor further includes a programmable timing means for disabling operations of the hearing aid device after a predetermined count is reached at the counter.

5. The hearing aid device of claim 1, wherein the controller stores in the memory data representative of a patient use diary data received at the interface.

6. The hearing aid device of claim 5, wherein the data are received from a wireless remote.

7. The hearing aid device of claim 5, wherein the data are received based on activation of switches on the hearing aid device.

8. The hearing aid device of claim 1, wherein the controller is operable to retrieve the patient use diary data from the memory and to transmit the patient use diary data at the interface.

9. The hearing aid device of claim 8, wherein the controller is operable, based on control data signals received at the interface.

10. The hearing aid device of claim 3, wherein the counter is resettable based on control signals received at the interface.

11. The hearing aid device of claim 1, wherein the controller is operable, based on control data signals received at the interface.

12. The hearing aid device of claim 1, wherein the controller causes the DSP to transmit at least one warning audio signal based on the count at the counter.

13. The hearing aid device of claim 12, wherein the at least one warning audio signal indicates that a time limit is almost reached.

14. The hearing aid device of claim 13, wherein the at least one warning audio signal is a sound emitted from the speaker.

15. The hearing aid device of claim 1, wherein the controller, upon receipt of new DSP correction factors signals at the interface, stores the new DSP correction factors in the memory.

16. A low-cost, programmable, time-limited hearing aid, comprising
means for programming the hearing aid with user-specific hearing-loss data for emulating the performance of a more permanent hearing aid device.

17. A method for using a low-cost, programmable, temporary hearing
aid, comprising the steps of
providing a controller including a processor and memory, wherein the controller is coupled to a microphone, a speaker and a data signal communications interface, wherein the processor is operable to execute an audio data signal processing program using digital signal processor (DSP) correction factors stored in the memory for modifying a sound input signal representative of sound input received at the microphone; and
wherein the processor includes a counter and a programmable timing means for disabling operations of the hearing aid device after a predetermined count is reached at the counter.

18. The method of claim 17, wherein the controller is capable of storing in the memory data representative of a patient's use data received at the interface.

19. The method of claim 17, wherein the controller is operable, based on control data signals received at the interface, to retrieve the patient use diary data from the memory and transmit the patient use diary data at the interface.

20. The method of claim 18, wherein the counter is resettable based on control signals received at the interface.

21. The method of claim 17, wherein the controller causes the DSP to transmit at least one warning audio signal based on the count at the counter.

22. The method of claim 17, wherein the controller, upon receipt of new DSP correction factors signals at the interface, stores the new DSP correction factors in the memory.
